(19) United States
(12) Patent Application Publication
(10) Pub. No.: US 2002/0118259 A1
(43) Pub. Date: Aug. 29, 2002

(54) Inking system and method

(76) Inventors: Nadeepuram Kuppanna Ranganathan, Irvine, CA (US); Barry R. Brucker, Beverly Hills, CA (US); Ramesh B. Subbaraman, Fullerton, CA (US)

Correspondence Address: George E Kersey, PO Box 1073, Framingham, MA, 01701, US

(21) Appl. No.: 09/537,738

(22) Filed: Mar. 29, 2000

(51) Int. Cl. B41J 2/175

(52) U.S. Cl. 347/85

(57) ABSTRACT

An ink jet printer comprises a container configured to hold ink, a first coupling component of a duplex coupler formed to the container, and a reservior configured to receive ink from the container. A complementary second coupling component of the duplex coupler is formed to the reservoir. The first coupling component is configured to mate with the second coupling component so as to mitigate leakage of ink.

### BACKGROUND OF THE INVENTION

This invention relates to systems for making inked imprints, and more particularly, to supplying ink for such systems.

One system for making inked imprints provides droplets on demand in response to transducer energization of one or more print heads that are supplied with ink. In some cases, such as the on-line printing of corrugated containers, large volumes of ink are required and suitably large supply containers of ink are needed.

In an impulse ink jet, positive pressure forces ink through chambers and orifices without the sucking back of ink. In one technique, a transport tube carrying ink between a supply chamber and a print head is squeezed to apply pressure that forces the ink to the printhead, followed by relief of the pressure to prevent back flow of ink from the print head.

The supply of pressure by squeezing a transport tube facilitates not only the removal of partially filled ink source containers but also the refilling of partially filled containers.

The desired squeezing of the ink transport tube is readily achieved by peristaltic pumping, having a roller moved into contact with the tube, then rolled along the tube to force ink to the printhead, followed by separation of the roller from the tube to allow the free flow of ink into the rolled area.

One technique providing a large ink supply for impulse ink jet printing is disclosed in U.S. Pat. 5,343,226 issued Sep. 28, 1997 to John Niedermeyer et al. and assigned to Dataproduct Corporation of Woodland Hills, Calif.

In Niedermeyer an impulse ink jet head is coupled to a ink reservoir that is supplied from a container with an opening for releasing ink by a valve in the opening. The valve is biased closed by a spring when the container when not mounted on the reservoir.

In particular, the Niedermeyer container is a bottle with a neck enclosing the spring and a portion of the valve. Both the cap and bottle have mutually engageable threads, and the actuating surface of the valve is exposed through the opening of the container to receive a stationary actuator mounted within the reservoir. In addition, the cap has exterior threads so that it can be screwed into the reservoir.

If there is misalignment between the stationary actuator of the reservoir and the actuating surface of the valve there can be interference with the ink supply. In addition, there can be ink leakage during the removal of a partially filled ink container because the valve does not close immediately during container removal by unscrewing the cap and bottle from the reservoir.

Accordingly, it is an object of the invention to provide an improved impulse ink jet head coupled to a ink reservoir supplied from a container having an opening for releasing ink from the container.

A related object is to improve the mechanism that controls the flow of ink from the container into the reservoir. Another related object is to improve the prevention of ink flow from the container when not mounted on the reservoir.

Still another object is to avoid the need for having the container take the form of a bottle with a neck enclosing a spring and a portion of the valve mechanism, and to avoid a valve with an actuating surface exposed that is required to contact a stationary actuator within an ink reservoir.

A further object of the invention is to avoid misalignment between a stationary actuator of a reservoir and a concave actuating surface of a valve, as well as avoid interference with the ink supply and ink leakage during the removal of a partially filled ink container because the valve does not close immediately during container removal.

### SUMMARY OF THE INVENTION

In accomplishing the foregoing and related objects, the invention provides an ink jet system with an ink reservoir connected to an ink jet head; a mechanism for causing ink flow from the reservoir to the ink jet head; and a mechanism for supplying ink to the reservoir independently of actuation by the reservoir.

In accordance with one aspect of the invention, the ink jet system uses a flexible tube for causing ink flow by applying pressure to the tube through a pumping orbit from a static position out of squeezing contact with the tube to a position of squeezing contact with the tube.

Ink is supplied to the reservoir independently of actuation by the reservoir by a duplex coupler having a first separable component insertable completely into a second component and locked in place.

Alternatively, the first component can be inserted partially into the second component of the duplex coupler, or can be completely separated from the second component. The first component of the duplex coupler, when separated from the second component and attached to a replaceable bottle of ink provides a sealed unit that is easily unsealed for the dispensing of ink by simply inserting the first component, with its attached bottle of ink into the second component.

When the second component is secured to the reservoir of an ink jet system, the complete insertion of the first component with its attached bottle of ink into the second component on the reservoir provides a flow path for ink into the reservoir. If the first component is only partially inserted into the second component, without actuating its flow through mechanism, but is nevertheless held securely in the second component, the first component remains sealed and there is no ink flow into the second component. Consequently, when ink is flowing into the reservoir through the duplex coupler and reaches a specified fill level, the filling procedure from the ink bottle is readily terminated by unlocking the connection between the first and second components which seals both of the components and thus provides an efficient spill-proof technique for controlling ink flow from the replaceable ink bottle into the reservoir.

In the duplex coupler for the ink jet system of the invention, the first component and the second component both have a front end and a back end, a first portion and a second portion, with a front end of the first component received in the second portion of the second component.

A poppet advantageously is reciprocally disposed in one component and acted upon by the other component to open a fluid passageway, and the other component can contain either a contactable poppet or a fixed post that is engaged by the poppet of the first component. When the second component contains a second poppet, which is reciprocally disposed in the second component, a tip end of the first poppet and a tip end of the second poppet can be engaged against each other, forcing each other to open a fluid passageway between the components.

A first spring can be compressively received between a poppet and a back end of one component, and second spring can be compressedly received between a poppet and a back end of the other component, so that the springs bias the poppets forwardly when their tip ends are disengaged from each other, as when the first component is disconnected from the second component.

In an ink jet system of the invention, a first coupling member can be-inserted into a second coupling member and locked in place, with at least one of the coupling members containing a poppet that closes when biased forwardly to seal the fluid passageway through the coupling member containing the poppet.

In a method of the invention for operating an ink jet system, the steps include (a) inserting one component of a two-component coupler in an ink reservoir; and (b) inserting the other component of the two-component coupler into a replaceable ink bottle.

In the method the first component can be partially inserted into the second component, or can be lockingly inserted into the second component.

When the first component is inserted into the second component, a push button of one component can be pressed to release the other component and seal a fluid passageway through the component that contains the push button.

The invention also provides a replaceable ink jet apparatus for an ink jet system formed by a container for ink-jet ink and having an outlet, and a cap for sealing the outlet of the container until ink in a reservoir of an ink-jet system is to be replenished.

The cap has a base positionable upon the container and a hollow neck extending from from the base, having an exterior surface containing a circumferential grove for receiving a locking collar when ink in a reservoir of an ink-jet system is to be replenished and a taper beyond said circumferential groove for facilitating the entry of the locking collar into the groove.

In accordance with one aspect of the replaceable ink jet apparatus, the container has ink-jet ink, the base is threaded upon the container and the cap seals the outlet until a reservoir of an ink-jet system is to be replenished.

In accordance with another aspect of the replaceable ink apparatus, the neck contains a flow channel with a reciprocable poppet therein and is biased closed to prevent the flow of ink from the container until needed to replenish ink in a reservoir of an ink-jet system. The poppet has a circumferential grommet for forming a circumferential seal.

### BRIEF DESCRIPTION OF THE DRAWINGS

FIG. 1 is an outline view of an ink jet system with an ink supply container connected to a reservoir by a duplex coupler in accordance with the invention;

FIG. 2A is a sectional view of the reservoir of FIG. 1 taken along the lines 2A-2A;

FIG. 2B is a sectional view of the reservoir connected component of the duplex coupler taken along the lines 2B-2B of FIG. 1;

FIG. 2C is a sectional view of the container connected component of the duplex coupler taken along the lines 2C-2C of FIG. 1;

FIG. 3 is a sectional view of the entire duplex coupler of FIG. 1 showing the flow path from the ink supply container to the reservoir;

FIG. 4A is a sectional view of an alternative reservoir of FIG. 1 taken along the lines 2A-2A;

FIG. 4B is a sectional view of the reservoir connected component of the alternative duplex coupler taken along the lines 2B-2B of FIG. 1;

FIG. 4C is a sectional view of the container connected component of the alternative duplex coupler taken along the lines 2C-2C of FIG. 1;

FIG. 5 is a sectional view of the entire duplex coupler of FIGS. 4B and 4C showing the flow path from the ink supply container to the reservoir.

### DETAILED DESCRIPTION

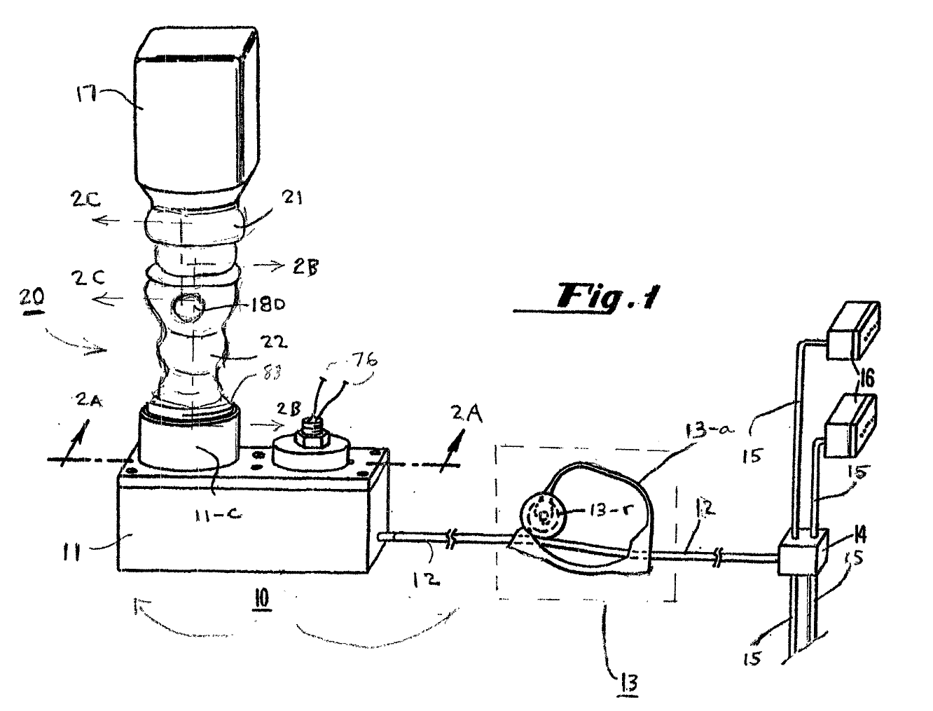

With reference to the drawings, the inking system 10 of FIG. 1 includes a reservoir 11 for a replaceable ink container 17 that is connected to the reservoir 11 by a duplex coupler 20. This allows replacement of the ink container 17 when the reservoir 11 is to be replenished, and the container is empty.

The duplex coupler 20 is formed by a first component 21 that is shown inserted into a second component 22. The first component 21, which is attached to the ink supply container 17, can be separated from the second component 22, which is threaded into a collar 11-c of the reservoir 11. When the separation of the components 21 and 22 takes place, as explained below, both components 21 and 22 are sealed, so that ink cannot leak from the container 17 or the reservoir 11.

A connector, such as a flexible tube 12, extends from the reservoir 11 to one or more ink jet heads, for example, by a manifold 14 that is fed from the reservoir 11 by a pump 13. The pump 13 includes a roller 13-r that is acted upon by a flexible arch 13-a to squeeze the tube 12 and force ink to the manifold 14.

The manifold 14, in turn, feeds a plurality of ink jet heads 16 through flexible tubes 15. Each of the heads 16 is formed by a plurality of ink jet units in accordance with U.S. Pat. No. 4,459,601 in which a transducer acts through a coupling on an ink jet chamber having an orifice for the ejection of droplets under electronic control. An input opening is supplied by the tubes 15 from the manifold 14. The heads 16 are positioned above the uppermost level of the ink supply reservoir 11 to avoid weeping from their input orifices.

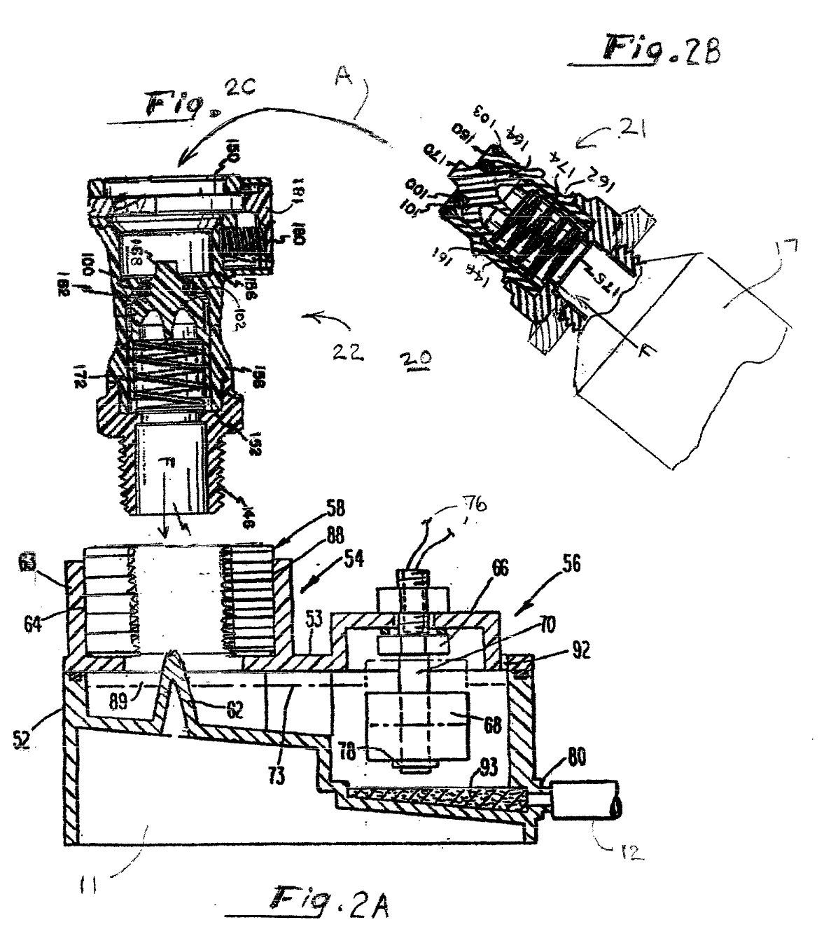

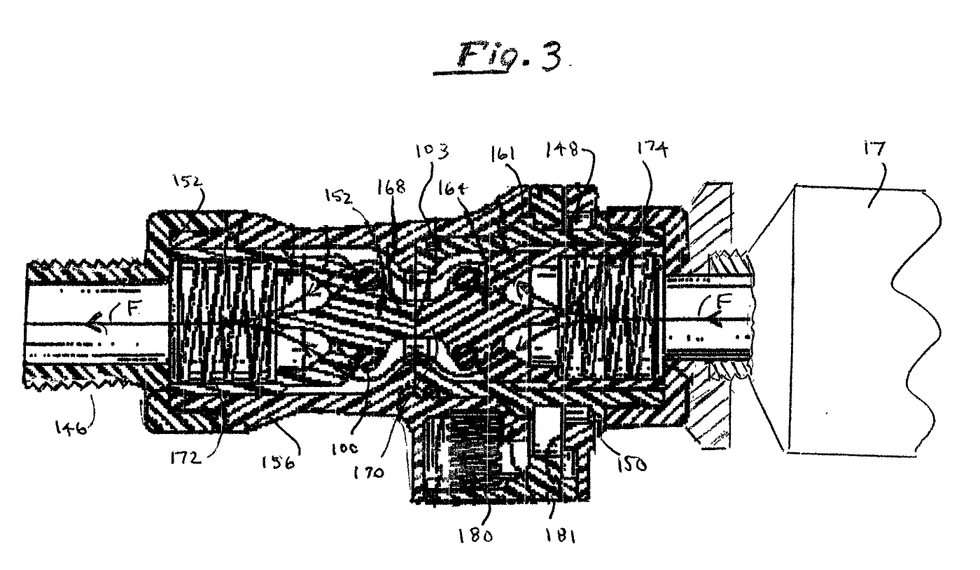

The reservoir 11 is filled from the container 17 through the duplex coupler 20 whose components are in cross-section in FIGS. 2B and 2C. After the second coupling component 22 of FIG. 2C has been threaded into the adapter 88 of the reservoir 11 in FIGS. 1 and 2A, the first coupling component 21 of FIG. 2B is insertable partially into the second component 22 for positioning, with both components sealed. Or the first component 21 is inserted fully into the second component 22, and locked in place, with both components unsealed to permit ink flow from the container 17 to the reservoir 11 as shown in FIG. 3.

The second coupling component 22 has a front end 150 and a back end 152, as well as a first portion 156 and a second portion 158. A front end 160 of the first coupling component 21 is receivable in the first portion 156 of the second coupling component 22 to form the connection shown in FIG. 3.

Further, as shown in FIG. 2C, a poppet 162, which is reciprocally disposed in the second housing portion 158 of the second coupling component 22, is aligned in FIG. 3 with a poppet 164 that is reciprocally disposed in a housing portion 148 of the first coupling member 21. After the component 21 has been moved into the component 22 in the direction of the arrow A, tip end 168 of the second poppet 162 and a tip end 170 of the first poppet 164 are engageable against each other, forcing each other to open a fluid passageway F as shown in FIG. 3 between the coupling components 21 and 22.

A spring 172 of FIG. 2C is compressively receivable between the poppet 162 and the back end 152 of the second coupling component 22. Similarly, a second spring 174 is compressedly receivable between the second poppet 164 and a back end 175 of the first coupling component 21. Therefore, spring members 172 and 174 bias the poppets 162 and 164 forwardly as indicated in FIGS. 2B and 2C when the tip ends 168 and 170 are disengaged from each other. This is the case when the first coupling component 21 is disconnected from the second coupling component 22.

Upon being biased forwardly, the poppets 162 and 164 seal and close the fluid passageway F through the coupling components 22 and 21, respectively. The disengagement to forwardly bias the poppets is accomplished by pressing the push button 180 which releases the components 21 and 22 from each other and allows the poppets 162 and 164 to seal their respective seats 101 and 102 by elastomeric rings 100.

The button 180 is connected to a reciprocable collar 181 in component 22 that is moved laterally across the bore of the component 22 when the component 21 is inserted and acted upon by its circumferential cam 161 to move the collar of the second component until the second component has been sufficiently inserted to allow the collar to move back and enter the circumferential groove 162 on the inserted first component 21.

If the first component 21 is inserted to the point where the cam 161 has not contacted the collar 181, an elastomeric ring 103 holds the first component 21 in the bore of the second component 22, with both components sealed. Thereafter the components 21 and 22 are easily pushed together to permit fluid flow. Similarly, when fluid flow is to be terminated, depression of the button 180 against its spring 181 quickly releases the components 21 and 22 from each other by the expansion of the spring 172 in the second component 22. This achieves a quick seal of the components when the flow of fluid to the reservoir 11 is to be terminated.

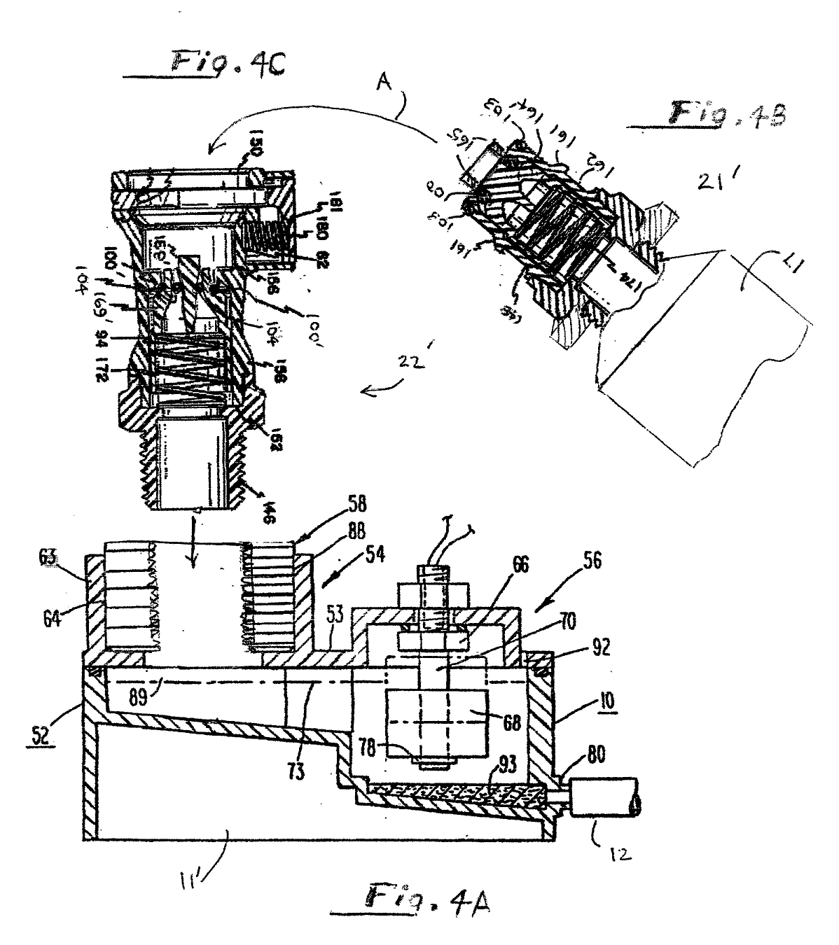

It will be appreciated that the tips on the poppets can be eliminated, as indicated in FIGS. 4B and 4C, by having one of the component replace its poppet by an axial post that is fixed within the component and extends to the level of engagement with a poppet in the other component. The axial post is surrounded by a spring loaded sleeve with sealing rings so that when the components are engaged, the post acts against an opposing poppet, and an extension of the housing surrounding the poppet depresses the sleeve in the other component to provide an equivalent though passage for the flow of ink.

As shown in the coupling component 22′ of FIG. 4C the poppet of FIG. 2C has been converted into a spring loaded sleeve 169′ surrounding a fixed post 168′, which may be flush with the sleeve 169′, or extend slightly beyond it as shown in FIG. 4C.

To engage the sleeve 169′, the first coupling component 21′ has an engagement ring 165′ mounted on either the flush end of the poppet 164′ or the end of the housing.

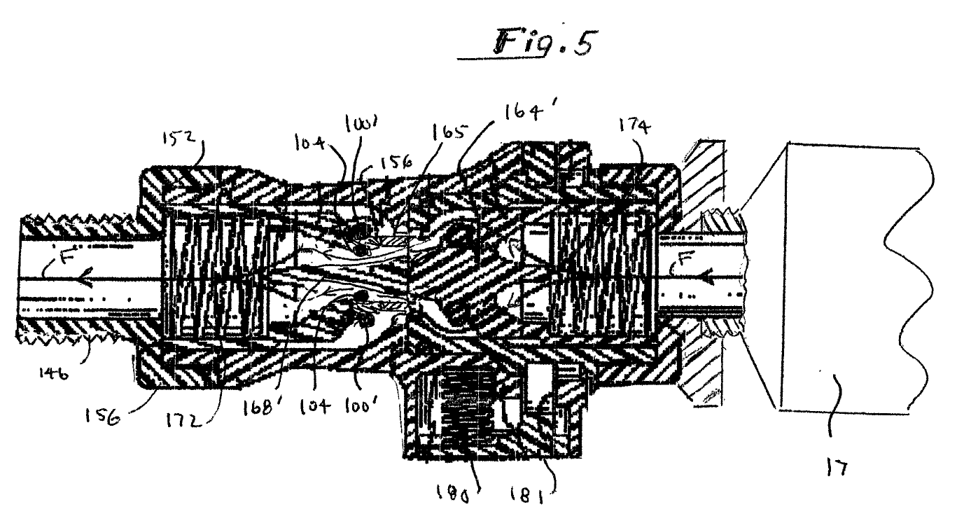

A further modification in the system of FIGS. 4A through 4C is the elimination in the reservoir 11′ of the actuator 62 from the reservoir 11 of FIG. 2A. The result of bringing the components 21′ and 22′ into a coupling connection between the container 17′ and the reservoir 11′, and the movement of the sealing rings 100′ and 104, are shown in FIG. 5.

To accomplish pumping from either the reservoir 11 or 11′, once filled though the duplex coupler 20 or 20′, the flexible tube 12 is contacted with the roller 13-r. When the pumping is actuated, the squeezing surface on the roller 13-r moves through an orbit to force ink through the flexible tube 12 during a pumping stroke. When the pressure of the roller 13-r is removed, the sucking of ink back through the tube 12 and the ink jet print head 14 is prevented. Initially, the roller 13-r is in a static position spaced from the tube 12. Thereafter, the roller is moved against the tube 12 and pressure is applied to commence a pumping stroke. At the conclusion of the pumping stroke, pressure is released and the roller is automatically lifted from the tube 12 to permit return to the decompressed position, and the roller 31 automatically moves back to its static position.

The ink reservoir 11 or 11′ permits a relatively large supply of ink to be used while facilitating efficient, ecologically sound and easy priming. The reservoir 11 or 11′ includes an ink supply base 52 with a cover 53 having a container support portion 54 and a level detect portion 56. The container support portion 54 includes an opening 58 in the cover 53 which extends upwardly and is adapted to receive the component 22 or 22′ of the duplex coupler 20 or 20′. After the component 22 or 22′ is inserted into the reservoir 11 or 11′, the first component 21 or 21′ is inserted into the second component 22 or 22′.

It will be appreciated that the container 17 may come with the first component 21 or 21′ in place, or the container may have a temporary shipping cap which is removed and replaced with the component 21 or 21′.

A neck 63 of the container 11 or 11′ extends upwardly from the cover 53 and includes threads 64 for receiving the ink supply adapter 88.

The level detector 56 in the cover 53 includes a level detect mechanism 66 with a float 68 that is free to move along a shaft 70 to the position shown in phantom, and a magnet located in an internal opening of the float 68 actuates a proximity switch to signal through wires 76 the level 73 of the ink within the reservoir 11. A washer 78 holds the float 68 on the shaft 79.

A port 80 in the base 52 allows connection to the tube 12 as shown in FIG. 1. A vent opening 92 is also provided in the top of the cover 53, and a filter 93 is in the base 52 adjacent the fitting 80.

The replaceable ink supply , when mounted on the cover 53 includes the duplex coupler 20 or 20′ by which easy interruption can be made of gravity feed of ink into the base 52 by simply depressing the button 80 or 80′ of the component 22 or 22′. As shown in FIGS. 2A and 4A, the duplex coupler 20 or 20′is engaged by the threaded cap 88. When the flow of ink to the reservoir is to be terminated, as signaled over the wires 76, the button 80 or 80 on the second coupling component 22 or 22′is depressed. This immediately seals both the first and second components.

It is to be noted that the base 52 also includes a member 62 that is used for ink supplies which require actuation of a valve enclosure inserted into the neck of the container 17 with an enclosed plunger.

The invention avoids the need for employment of the member 62 and provides an instant non-leaking seal of the components 21 and 22 when the flow of ink into the reservoir 11 is to be terminated.

In this manner, flow of ink from the container 17 is precisely controlled after mounting of the first coupling component 21 on the second component 22 without locking engagement. Once the first component is pushed into the second component to be locked in place ink is permitted to flow to the base 52 of the reservoir 11 without without any leakage from the container 17. It also will be appreciated that the container 17 may be readily refilled after removal from the base 52 by simply unscrewing the first coupling component 21, thereby providing an ecologically suitable supply replenishment.

The manifold 14 is optional and a single head 16 may be used with the peristaltic pumping apparatus 12.

It will also be appreciated that the manifold 14 may be used with a plurality of peristaltic pumping apparatus 14, one for each tube 20.

Although a particular embodiment of the invention has been shown and described, it will be appreciated that other modifications and embodiments will occur to those of ordinary skill in the art which will fall within the true spirit and scope of the appended claims.

What is claimed:

1. An ink jet system comprising:
an ink reservoir connected to an ink jet head;
means for causing ink flow from said reservoir to said ink jet head; and
means for supplying ink to said reservoir independently of actuation by said reservoir.

2. An ink jet system of claim 1 wherein said means for causing ink flow comprises a flexible tube; and
means for applying pressure to said tube through a pumping orbit from a static position out of squeezing contact with said tube to a position of squeezing contact with said tube.

3. An ink jet system of claim 1 wherein said means for supplying ink to said reservoir independently of actuation by said reservoir comprises a duplex coupler.

4. An ink jet system of claim 3 wherein said duplex coupler of said means for supplying ink to said reservoir independently of actuation by said reservoir comprises a first separable component inserted completely into a second component and locked in place.

5. An ink jet system of claim 3 wherein said duplex coupler of said means for supplying ink to said reservoir independently of actuation by said reservoir comprises a first component inserted partially into a second component.

6. An ink jet system of claim 3 wherein said duplex coupler of said means for supplying ink to said reservoir independently of actuation by said reservoir comprises a first component separated from a second component.

7. An ink jet system of claim 4 wherein said said first component and said second component both have a front end and a back end, a first portion and a second portion, with a front end of said first coupling member received in the second portion of said second coupling member.

8. An ink jet system of claim 4 wherein a poppet is reciprocally disposed in one component and acted upon by the other component to open a fluid passageway.

9. An ink jet system of claim 8 wherein said other component contains a fixed post.

10. An ink jet system of claim 8 a second poppet is reciprocally disposed in said other component, with a tip end of the first poppet and a tip end of said second poppet engaged against each other, forcing each other to open a fluid passageway between the component.

11. An ink jet system of claim 4 wherein a first spring is compressively received between a poppet and a back end of said first component, and second spring is compressedly received between a poppet and a back end of said second component;
whereby the springs bias the poppets forwardly when their tip ends are disengaged from each other when said first component is disconnected from said second component.

12. An ink jet system of claim 4 wherein said duplex valve of said means for supplying ink to said reservoir independently of actuation by said reservoir comprises
a first coupling member inserted into a second coupling member and locked in place;
at least one of the coupling members contains a poppet that closes when biased forwardly to seal the fluid passageway through the coupling member containing said poppet.

13. The method of operating an ink jet system, including the steps of:
(a) inserting one component of a two-component coupler in an ink reservoir; and
(b) inserting the other component of said two-component coupler into a replaceable ink bottle.

14. The method of claim 13 wherein said first component is partially inserted into said second component.

15. The method of claim 13 wherein said first component is lockingly inserted into said second component.

16. The method of claim 13 wherein said first component is inserted into said second component and a push button of one component is pushed to release the other component and seal a fluid passageway through the component that contains said push button.

17. Replaceable ink jet apparatus for an ink jet system, comprising
a container for ink-jet ink and having an outlet; and
a cap for sealing the outlet of said container until ink in a reservoir of an ink-jet system is to be replenished;
said cap comprising a base positionable upon said container and a hollow neck extending from from said base and having an exterior surface containing (1) a circumferential grove for receiving a locking collar when ink in a reservoir of an ink-jet system is to be replenished and (2) a taper beyond said circumferential groove for facilitating the entry of said locking collar into said groove.

18. Replaceable ink jet apparatus as defined in claim 17 wherein said container has ink-jet ink, said base is threaded upon said container and said cap seals said outlet until a reservoir of an ink-jet system is to be replenished.

19. Replaceable ink jet apparatus as defined in claim 17 wherein said neck contains a flow channel with a reciprocable poppet therein and means for biasing said poppet closed to prevent the flow of ink from said container until said container is needed to replenish ink in a reservoir of an ink-jet system.

20. A replaceable ink jet assemblage as defined in claim 17 wherein said poppet has a circumferential grommet for forming a circumferential seal.
